(19) United States
(12) Patent Application Publication
(10) Pub. No.: US 2009/0260066 A1
(43) Pub. Date: Oct. 15, 2009

(54) Single Sign-On To Administer Target Systems with Disparate Security Models

(75) Inventors: James Miller, Lombard, IL (US); Senthilvel Saravanan, San Jose, CA (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Aspect Software Inc., Lombard, IL (US)

(21) Appl. No.: 12/100,103

(22) Filed: Apr. 9, 2008

(51) Int. Cl. H04L 9/32; G06F 21/00

(52) U.S. Cl. 726/6; 726/8

(57) ABSTRACT

A method and apparatus are provided for signing a user into a computer network associated with an automatic contact distribution system. The method includes the steps of providing a sign-on list that identifies a plurality of subsystems of the computer network of the automatic contact distribution system that the user had previously signed onto, detecting the user signing into the system, retrieving the sign-on list and automatically signing the user into each of the plurality of subsystems identified by the list.

### FIELD OF THE INVENTION

The field of the invention relates to computer systems and more particularly to interconnected computer systems.

### BACKGROUND OF THE INVENTION

The difficulty of providing access to users within interconnected computer systems is generally known. One or more interconnected computers are typically required whenever the task is too large for a single computer or where specific tasks are provided by different independent systems and the activities of the computers must be coordinated.

Automatic call distributors (ACDs) are an example of such a situation. ACDs are typically used by telemarketers and/or service providers and are typically provided with a host computer that makes and receives calls.

Workforce management, and performance optimization systems (operating within an ACD or otherwise) are examples of the different tasks that may be distributed over a number of hosts. In addition to making and receiving calls, the host of an ACD may also act as a repository of customer records.

In order to reduce telephone costs, telemarketers often locate a number of ACDs of an ACD system near major metropolitan areas. However, during periods of overload calls may be handled through any ACD of the ACD system. As a result, the host or hosts of each ACD must be accessible from any agent station throughout the system.

While the interconnecting of hosts of ACDs works relatively well, the problem of security is difficult to administer. The difficulty often arises because of the need of a user to access many different databases. Often the only way of providing access to the user into different databases of the system is to manually save a name and password of the user into each different host.

The need for the manual entry of data to gain access to the different databases is slow and cumbersome. Because of the importance of ACDs and of interconnected computers, a need exists for a better method of providing access to users within such computer systems.

### SUMMARY

A method and apparatus are provided for signing a user into a computer network associated with an automatic contact distribution system. The method includes the steps of providing a sign-on list that identifies a plurality of subsystems of the computer network of the automatic contact distribution system that the user had previously signed onto, detecting the user signing into the system, retrieving the sign-on list and automatically signing the user into each of the plurality of subsystems identified by the list.

### BRIEF DESCRIPTION OF THE DRAWINGS

FIG. 1 is a block diagram of a computer system under an illustrated embodiment of the invention.

### DETAILED DESCRIPTION OF AN ILLUSTRATED EMBODIMENT

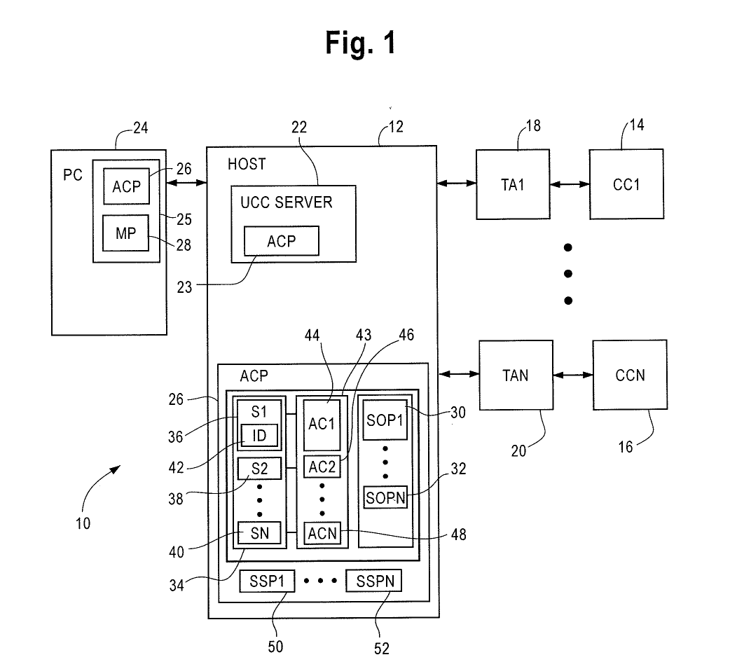

FIG. 1 is a block diagram of a networked computer system 10 that allows a user to securely log into a number of different security domains (e.g., servers) within the computer system 10 using only a single set of credentials (e.g., a name and password) entered only once. The networked computer system 10 of FIG. 1 is shown generally in accordance with an illustrated embodiment of the invention.

The computer system 10 may be an automatic contact distribution system having at least one host 12 that provides a unified command and control to the system 10. Connected to the host 12 may be one or more automatic configuration, call or contact distributors, workforce management or quality management servers (together referred to hereinafter as “ACDs 14, 16”). The ACDs 14, 16 may be coupled to the host 12 through a respective terminal adapter (TA) 18, 20.

The ACDs 14, 16 may be legacy or relatively new ACDs. In the case where the ACDs 14, 16 are a mix of conventional and legacy systems, a respective terminal adapter 18, 20 may be used to adapt the instruction sets and protocols of the ACDs 14, 16 to the host 12.

The host 12 may include one or more command and control servers 22. The servers 22 may be accessed by one or more desktops 24 operating on a PC connected to the host 12.

The host 12 and servers 22 may be used to provide administrative and control support for enhanced use of the ACDs 14, 16. For example, the ACDs 14, 16 may be located in remote geographic areas and process contacts with clients through a local connection to one or more communication systems (e.g., the PSTN, the Internet, etc.). As the calls are processed by the ACDs 14, 16, a supervisor working through the desktops 24 may monitor a call loading of the ACDs 14, 16. By being able to monitor a loading of each ACD 14, 16, the supervisor may detect overloaded agent groups, adjust the number of agents available for each call type, and even change a criteria for routing of calls among the ACDs 14, 16.

In order to adjust the number of agents available for each call type, the supervisor may need to first log into the various ACDs 14, 16. Once logged into an ACD 14, 16, the supervisor may be free to alter the size and content of the agent groups. In this regard, the supervisor may transfer agents among agent groups of an ACD 14, 16 or even alter the contact routing criteria that causes calls to be routed to any particular call group among the ACDs 14, 16.

However, the ACDs 14, 16 may be a mix of legacy and newer contact centers, each representing a separate security domain. For each legacy ACD 14, 16, the user may need to enter a unique user name and password to gain access to each ACD 14, 16. Once access has been granted, security may simply be based upon source and destination URLs.

For newer ACDs 14, 16, other security features may control based upon other security requirements (e.g., token keys, two-factor authentication, etc.). For example, once the user has been authenticated by a first application (e.g, Windows) within a domain, the first application may issue a token key for the user to pass to other applications within the domain. The other applications may verify the authority of the user to access the other applications via the token key and other related domain security features (e.g., LDAP).

In general, the supervisor working through a desktop 24 may activate a browser 25 with his/her desktop 24. The supervisor may enter a URL of the host 12 to access the host 12. The host 12 may download a user client to the desktop 24. The user client may requested a user name and password from the supervisor as a prerequisite for access. If the supervisor should provide a valid set of credentials, then a access control program (e.g., a Windows authentication mechanism) 23 may grant access to the domain represented by the UCC server 22.

Once the supervisor 24 has gained access to the server 22, an access control program 26 either within the host 12 or desktop 24 may monitor the activities of the supervisor for subsequent sign ins to other domains. In each case, as the supervisor accesses a server of another domain, the access control program 26 detects the security challenge returned by the server in response to the access attempt and saves the response into a database. The next time that the supervisor signs into the system 10, the access control program 26 detects the initial sign on of the supervisor into the domain of the UCC 22 and automatically signs the supervisor into any other domain that the supervisor had previously signed into.

Where the access control program 26 is located within the host 12, then a monitoring program 28 may be provided within the browser 25 of the desktop 24 to detect access requests. In this case, the monitoring program 28 may detect access requests and forward a copy of the request to the access control program 26.

In either case, the access control program 26 may detect an attempt to access additional domains by comparing data packets exchanged by the browser 25 with one or more access profiles 30, 32. As is known, computer systems that include a mix of legacy and conventional hardware and software may use a mix of different security models and different access protocols. The use of the different access profiles 30, 32 allows the access control program 26 to detect access requests and also the type of security model used by the target of the access request. In this case, access requests are compared with the characteristics defined by each of the security access profiles 30, 32 and when a match is found, then the access control program 26 performs a series of steps associated with the request.

In addition to access requests, the access profiles 30, 32 may also be used to detect password changes. In this case, the access control program 26 captures name and password changes and processes the changes in a similar manner.

As a first step, the access control program 26 may monitor the desktop 24 to determine if the access request or password change was successful. If the access request or password change is not successful, then the access control program 26 may simply discard the information.

If the sign on is successful, then the access program 26 may perform a series of other, additional steps. After a successful sign on by the supervisor, the access control program 26 may recover a number of information elements from the access request and use the recovered elements in conjunction with the security model type to compose a sign on list 34.

Included within the sign on list 34 may be a list of domain identifiers 36, 38, 40 (e.g., ACDs 14, 16). Also included within the sign on list 34 may be an identifier 42 of the particular type of security model used by the domain 14, 16.

Also associated with each entry 36, 38, 40 within the list 34 is a set of authentication credentials 44, 46, 48 recovered from a successful sign on by the supervisor with the respective domains. For example, if the supervisor has a set of credentials including a user name of “John”, a password of “pass1” and signs into a first domain (e.g., ACD 14) with the name “server1@ACD14”, then the access control program 26 may save the identifier “server1@ACD14” in a first file 36 of the list 34 along with the security model type (e.g., “securitymodel1”) in the subfile 42 and the supervisor's credentials (e.g., “John” and “pass1”) as a specific entry 44 associated with the file 36 within a database or repository 43. In this case, the entry 44 including the user credentials are encrypted into the database or repository 43 to prevent unauthorized use of the supervisor's access credentials. Encryption may be accomplished using a known encoding key.

Similarly, the supervisor may choose to log into a second domain (e.g., AC 16) with the domain identifier “server1@ACD 16” using a second security model (e.g., “securitymodel2”) that requires a different set of security credentials (e.g., user name (e.g., “John1”), password (e.g., “pass2”) and a URL of the supervisor (e.g., “John@UCC”)). In this case, the access control program 26 may save the identifier “server1@ACD 16” in a second file 38 of the list 34 along with the security model type (e.g., “securitymodel2”) in the subfile 42 and the supervisor's credentials (e.g., “John1”, “pass2” and “John@UCC”) as a specific entry 46 associated with the file 38 within a database or repository 43. As above, the entry 46 including the user credentials are encrypted into the database or repository 43 to prevent unauthorized use of the supervisor's access credentials.

Upon a subsequent sign in of the supervisor into the system 10, the access control program 26 detects the initial sign in of the supervisor into the system 10 and then proceeds to automatically sign the supervisor into the other previously accessed domains. Signing of the supervisor into the various domains may be accomplished by one or more sign on programs 50, 52 where each program 50, 52 is associated with a particular type of security model. For example, a first program 50 may be used in conjunction with a first security model (e.g., “securitymodel1”) and a second program 52 may be used in conjunction with a second security model (e.g., “securitymodel2”).

In this regard, the access control program 26 may first retrieve the list 34 and proceed to sign the supervisor into each domain found within the list. The access program 26 may retrieve a first sign in file 36 and determine the type of security from the security model file 42. If the security model file 42 indicates a first type of security model (e.g., “securitymodel1”), then the access program 26 may transfer the sign on file 36 to a first sign on program 50. If the security model file 42 indicates a second type of security model (e.g., “securitymodel2”), then the access program 26 may transfer the sign on file 36 to another sign on program 52.

Upon receipt of the files 36, 38, 40, the sign on programs 50, 52 may retrieve the respective security credentials 44, 46, 48 and proceed to sign the supervisor into the associated domains. In each case, the sign on program 50, 52 may compose a sign on request using the name of the domain, the credentials of the user and the particular sign on format required by the domain.

Sign on by the access control program 26 may be entirely transparent to the user. If the sign on fails, then the user is prompted to manually enter his/her credentials. As the access control program 26 signs the supervisor into each new domain, an icon representing the domain may appear on the supervisor's desktop 24. Access through the icon may be accomplished as if the supervisor had signed into domain directly.

In another embodiment, the access control program 26 may be used by a controlling supervisor to set up the profiles and roles (i.e., rights and privileges) of other supervisors or other targeted users. The targeted users may be administrators in target systems (e.g., ACDs 14, 16) or even agents working through the individual ACDs 14, 16. In any case, the supervisor working through the desktop 24 may make entries directly into the sign on list 34 for other users to create a sign on list 34 appropriate for the user.

Alternately, a default user name and user password may be provided for use within each domain of the system 10. The default user name and password may be changed daily or may only be valid for a short period of time to deter unauthorized use. The default user name and password may be created by the controlling supervisor as a convenient method of bring new users into the system 10.

New users may be provided with the default user names and passwords for initial sign on. Any use of the default user names and passwords may cause the access control program 26 to create a sign on list 34 in response to the use of the default user names and passwords. As the user signs into each domain, the domain may allow access, but immediately require that the new user change his/her user name and password. As the new user provides a new user name and password, the access control program 26 captures the credentials and saves them to the database or repository 43.

Alternatively, default user passwords may be provided by the controlling supervisor that work with any user name. This has the added advantage that a user is not confused by having to use a different user name. In addition, the requirement of the same user name in all cases provides an easier method through which access may be tracked.

A specific embodiment of method and apparatus for automatically signing a user into a multitude of different domains has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of signing a user into a computer network associated with an automatic contact distribution system comprising:
providing a sign-on list that identifies a plurality of subsystems of the computer network of the automatic contact distribution system that the user had previously signed onto;
detecting the user signing into the system;
retrieving the sign-on list; and
automatically signing the user into each of the plurality of subsystems identified by the list.

2. The method of signing the user into the system as in claim 1 further comprising retrieving a respective set of authentication credentials for each subsystem of the plurality of subsystems from a database or repository.

3. The method of signing the user into the system as in claim 2 wherein the step of retrieving the respective sets of authentication credentials further comprises decoding the respective sets from the database or repository using a decoding key.

4. The method of signing the user into the system as in claim 2 wherein the step of signing the user into the subsystems further comprises composing a sign-on message for each respective subsystem including an identifier of the subsystem and retrieved authentication credentials for the subsystem.

5. The method of signing the user into the system as in claim 2 wherein the authentication credentials further comprises a user name and associated password.

6. The method of signing the user into the system as in claim 2 wherein the authentication credentials further comprises an optional authentication token.

7. The method of signing the user into the system as in claim 2 wherein the authentication credentials further comprises a combination of at least some user names and respective associated passwords and at least some authentication tokens.

8. The method of signing the user into the system as in claim 2 further comprising detecting the user signing into another subsystem using the set of authentication credentials.

9. The method of signing the user into the system as in claim 8 wherein the step of saving an identifier of the other system into the sign-on list further comprises encoding the authentication credentials of the other subsystem into a database or repository.

10. An apparatus for signing a user into a computer network associated with an automatic contact distribution system comprising:
means for providing a sign-on list that identifies a plurality of subsystems of the computer network of the automatic contact distribution system that the user had previously signed onto;
means for detecting the user signing into the system;
means for retrieving the sign-on list; and
means for automatically signing the user into each of the plurality of subsystems identified by the list.

11. The apparatus for signing the user into the system as in claim 10 further comprising means for retrieving a respective set of authentication credentials for each subsystem of the plurality of subsystems from a database or repository.

12. The apparatus for signing the user into the system as in claim 11 wherein the means for retrieving the respective sets of authentication credentials further comprises means for decoding the respective sets from the database or repository using a decoding key.

13. The apparatus for signing the user into the system as in claim 11 wherein the means for signing the user into the subsystems further comprises means for composing a sign-on message for each respective subsystem including an identifier of the subsystem and retrieved authentication credentials for the subsystem.

14. The apparatus for signing the user into the system as in claim 11 wherein the authentication credentials further comprises a user name and associated password.

15. The apparatus for signing the user into the system as in claim 11 wherein the authentication credentials further comprises an optional authentication token.

16. The apparatus for signing the user into the system as in claim 11 wherein the authentication credentials further comprises a combination of at least some user names and respective associated passwords and at least some authentication tokens.

17. The apparatus for signing the user into the system as in claim 11 further comprising means for detecting the user signing into another subsystem using the set of authentication credentials.

18. The apparatus for signing the user into the system as in claim 15 wherein the means for saving an identifier of the other system into the sign-on list further comprises means for encoding the authentication credentials of the other subsystem into a database or repository.

19. An apparatus for signing a user into a computer network associated with an automatic contact distribution system comprising:
a sign-on list that identifies a plurality of subsystems of the computer network of the automatic contact distribution system that the user had previously signed onto;
a first server that detects the user signing into the system; and
a sign on program that retrieves the sign-on list and automatically signs the user into each of the plurality of subsystems of other domains identified by the list.

20. The apparatus for signing the user into the system as in claim 19 further comprising a respective set of authentication credentials for each subsystem of the plurality of subsystems that is retrieved by the sign on program from a database or repository.

21. The apparatus for signing the user into the system as in claim 20 further comprises a decoding key that is used to decode the respective sets of authentication credentials from the database or repository using a decoding key.

22. The apparatus for signing the user into the system as in claim 20 further comprising a sign-on message composed by the sign on program for signing onto each respective subsystem including an identifier of the subsystem and retrieved authentication credentials for the subsystem.

23. The apparatus for signing the user into the system as in claim 20 wherein the authentication credentials further comprises a user name and associated password.

24. The apparatus for signing the user into the system as in claim 20 wherein the authentication credentials further comprises an optional authentication token.

25. The apparatus for signing the user into the system as in claim 20 wherein the authentication credentials further comprises a combination of at least some user names and respective associated passwords and at least some authentication tokens.

26. The apparatus for signing the user into the system as in claim 20 further comprising means for detecting the user signing into another subsystem using the set of authentication credentials.
